(19) United States
(12) Patent Application Publication
(10) Pub. No.: US 2012/0144322 A1
(43) Pub. Date: Jun. 7, 2012

(54) APPARATUS AND METHOD FOR NAVIGATING MOSTLY VIEWED WEB PAGES

(75) Inventor: Sang-Min PARK, Seoul (KR)

(73) Assignee: SAMSUNG ELECTRONICS CO., LTD., Gyeonggi-Do (KR)

(21) Appl. No.: 13/309,798

(22) Filed: Dec. 2, 2011

(30) Foreign Application Priority Data
Dec. 7, 2010 (KR) 10-2010-0124127

(51) Int. Cl. G06F 3/01

(52) U.S. Cl. 715/760

(57) ABSTRACT

The present invention discloses an improved way of navigating and moving elements between layers by storing related web pages in a hierarchical manner so that, based on a particular event during a display of a predetermined web page among a plurality of most viewed web pages, the predetermined web page and other webpages from other layers are displayed according to a predefined criteria.

### CLAIM OF PRIORITY

This application claims the benefit under 35 U.S.C. §119 of a Korean Patent Application filed in the Korean Intellectual Property Office on Dec. 7, 2010 and assigned Serial No. 10-2010-0124127, the entire disclosure of which is hereby incorporated by reference.

### BACKGROUND OF THE INVENTION

1. Field of the Invention

The present invention generally relates to an apparatus and method for navigating mostly viewed sites, and more particularly, to an apparatus and method for improving a navigation of previously visited sites along with other element of layers according to a predetermined criteria.

2. Description of the Related Art

Conventionally, the number of visit history to a web page(s) is stored on a Uniform Resource Locator (URL) basis and provided to a user according to most frequent visiting order.

FIGS. 1A and 1B are diagrams showing displayed web pages according to prior art.

As shown in FIG. 1A, upon selection of “Most visited”, a plurality of web pages that user visited the most is provided for viewing. As shown in FIG. 1B, upon selection of “History”, web pages are provided in the form of a list in order of the visits to the web pages.

However, since the web pages that are mostly viewed are merely a representation of frequently visited web pages having no relation therebetween, movement to a related web page between layers cannot be made.

For example, when A (www.samsung.com) has web pages B1 (www.samsung.com/B1) and B2 (www.samsung.com/B2) in its lower layer, B1 has a web page C1 (www.samsung.com/B1/C1) in its lower layer, B2 has a web page C2 (www.samsung.com/B2/C2) in its lower layer, and when these web pages all are visited, among which the web page B1 is most frequently visited. Then, only the web page B1 is displayed as mostly viewed site, then a selection/movement can be made in the web page B1 only to the lower layer of the web page B1, and not to the upper layer of the web page B1 where the web page A is displayed, or to the same layer as the web page B1 where the web page B2 is displayed.

As a result, to display the web page A in the upper layer of the web page B1 or the web page B2 in the same layer as the web page B1, the corresponding web page has to be visited again, thus causing inconvenience to a user and incurring a cost due to additional network use.

### SUMMARY OF THE INVENTION

Accordingly, an aspect of the present invention is to provide an apparatus and method for improving mostly viewed sites, which facilitates the movement to a related web page between layers.

According to an aspect of the present invention, an apparatus for improving a navigation of mostly viewed sites includes a memory for storing related web pages in a hierarchical manner and a controller for, based on a particular event occurring on a predetermined web page among a plurality of web pages displayed in the mostly viewed sites, moving to a corresponding layer of the predetermined web page and displaying a corresponding web page.

According to another aspect of the present invention, a method for improving a navigation of mostly viewed sites includes displaying a plurality of web pages in a mostly viewed mode and based on a particular event occurring on a predetermined web page among a plurality of web pages displayed in the most view mode, moving to a corresponding layer of the predetermined web page and displaying a corresponding web page.

### BRIEF DESCRIPTION OF THE DRAWINGS

The above and other features and advantages of an exemplary embodiment of the present invention will be more apparent from the following detailed description taken in conjunction with the accompanying drawings, in which:

FIGS. 1A and 1B are diagrams showing displayed web pages according to prior art;

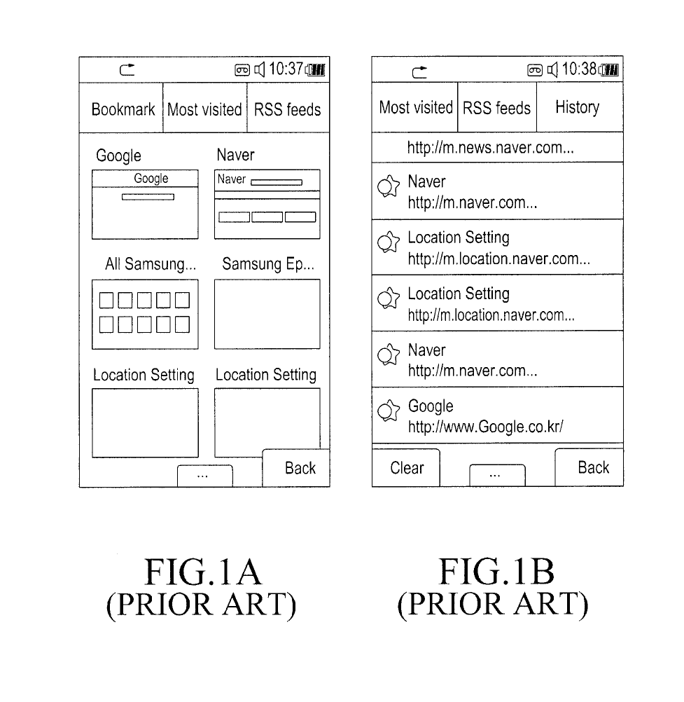

FIG. 2 is a block diagram of a portable terminal according to an embodiment of the present invention;

FIG. 3 is a flowchart illustrating a process of moving between web pages displayed in a most view in a portable terminal according to an embodiment of the present invention; and

FIGS. 4A through 4D are diagrams for describing FIG. 3.

### DETAILED DESCRIPTION OF THE INVENTION

Hereinafter, an exemplary embodiment of the present invention will be described in detail with reference to the accompanying drawings. Throughout the drawings, like components will be indicated by like reference numerals.

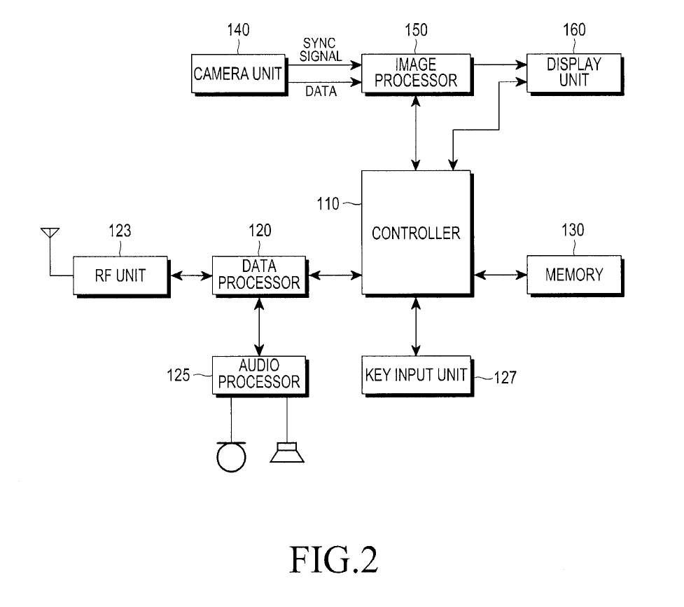

FIG. 2 is a block diagram of a portable terminal according to an embodiment of the present invention.

Referring to FIG. 2, a Radio Frequency (RF) unit 123 performs a wireless communication function of the portable terminal. The RF unit 123 includes an RF transmitter for up-converting a frequency of a transmission signal and amplifying the transmitted signal and an RF receiver for low-noise amplifying a received signal and down-converting the frequency of the received signal. A data processor 120 includes a transmitter for encoding and modulating the transmission signal and a receiver for demodulating and decoding the received signal. The data processor 120 may include a modem and a codec. Herein, the codec includes a data codec for processing packet data and an audio codec for processing an audio signal such as voice. An audio processor 125 reproduces an audio signal being output from the audio codec of the data processor 120 or transmits an audio signal generated from a microphone to the audio codec of the data processor 120.

A key input unit 127 includes keys for inputting numeric and character information and function keys for setting various functions.

A memory 130 includes program and data memories. The program memory stores programs for controlling a general operation of the portable terminal and programs for moving to a web page related to a predetermined web page in a most view according to an embodiment of the present invention.

The memory 130 stores related web pages visited in a hierarchical manner according to an embodiment of the present invention.

A controller 110 controls overall operation of the portable terminal.

According to an embodiment of the present invention, based on a particular event occurring on a predetermined web page among a plurality of web pages mostly viewed, the controller 110 moves to a corresponding layer of the predetermined web page relative to other elements on the screen so that the user can navigate, not just the traditional way, but a new way to dynamically forward (upper) and backward (below) on the screen.

Here, the particular event may be a zoom-out event, a zoom-in event, or a scroll event. Thus, according to an embodiment of the present invention, upon occurrence of the zoom-out event or an upward-scroll event during a display of a predetermined web page among the plurality of web pages, the controller 110 moves to an upper layer of the predetermined web page to display (1) the predetermined web page, (2) a web page in the same layer as the predetermined web page, and (3) a web page in the upper layer of the predetermined web page. Here, the controller 110 displays (1) the predetermined web page, (2) the same-layer web page, and (3) the upper-layer web page differently by applying different sizes, colors, positions, etc. to those web pages for distinction.

Moreover, according to an embodiment of the present invention, upon occurrence of the zoom-in event or a downward-scroll event during a display of a predetermined web page among the plurality of web pages, the controller 110 moves to a lower layer of the predetermined web page to display (1) the predetermined web page and (2) a web page(s) in a lower layer of the predetermined page. Here, the controller 110 displays (1) the predetermined web page and (2) the lower-layer web page differently by applying different sizes, colors, positions, etc. to those web pages for distinction.

Further, according to an embodiment of the present invention, upon occurrence of a left-right-scroll event during a display of a predetermined web page among the plurality of web pages, the controller 110 moves to (1) the same layer as the predetermined web page to display a web page in the same layer and (2) a web page(s) in a lower layer of the same layer. Here, the controller 110 displays the same-layer web page and the lower-layer web page thereof differently by applying different sizes, colors, positions, etc. to those web pages for distinction.

A camera module 140 captures an image, and may include a camera sensor for converting an optical signal of the captured image into an electrical signal, and a signal processor for converting an analog image signal of the image captured by the camera sensor into digital data. Herein, it is assumed that the camera sensor is a Charge Coupled Device (CCD) sensor or a Complementary Metal Oxide Semiconductor (CMOS) sensor, and the signal processor may be implemented as a Digital Signal Processor (DSP). In addition, the camera sensor and the signal processor may be implemented as one piece or separately.

An image processor 150 performs Image Signal Processing (ISP) to display an image signal output from the camera module 140 on the display unit 160. The ISP executes functions such as gamma correction, interpolation, space conversion, image effect, image scale, Auto White Balance (AWB), Auto Exposure (AE) and Auto Focus (AF). Thus, the image processor 150 processes the image signal output from the camera module 140 in the unit of a frame, and outputs frame image data adaptively to the features and size of the display unit 160. The image processor 150 includes an image codec, and compresses the frame image data displayed on the display unit 160 in a preset manner or restores the compressed frame image data to the original frame image data. Herein, the image codec may be Joint Picture Experts Group (JPEG) codec, Moving Picture Experts Group 4 (MPEG4) codec, or Wavelet codec. It is assumed that the image processor 150 has an on screen display (OSD) function. The image processor 150 may output OSD data according to the displayed picture size under the control of the controller 110.

The display unit 160 displays an image signal output from the image processor 150 on the screen and displays user data output from the controller 110. Herein, the display unit 160 may be a Liquid Crystal Display (LCD), and in this case, the display unit 160 may include an LCD controller, a memory capable of storing image data, an LCD element, and so on. When the LCD is implemented with a touch screen, it may serve as an input unit. In this case, on the display unit 160, keys such as the key input unit 127 may be displayed.

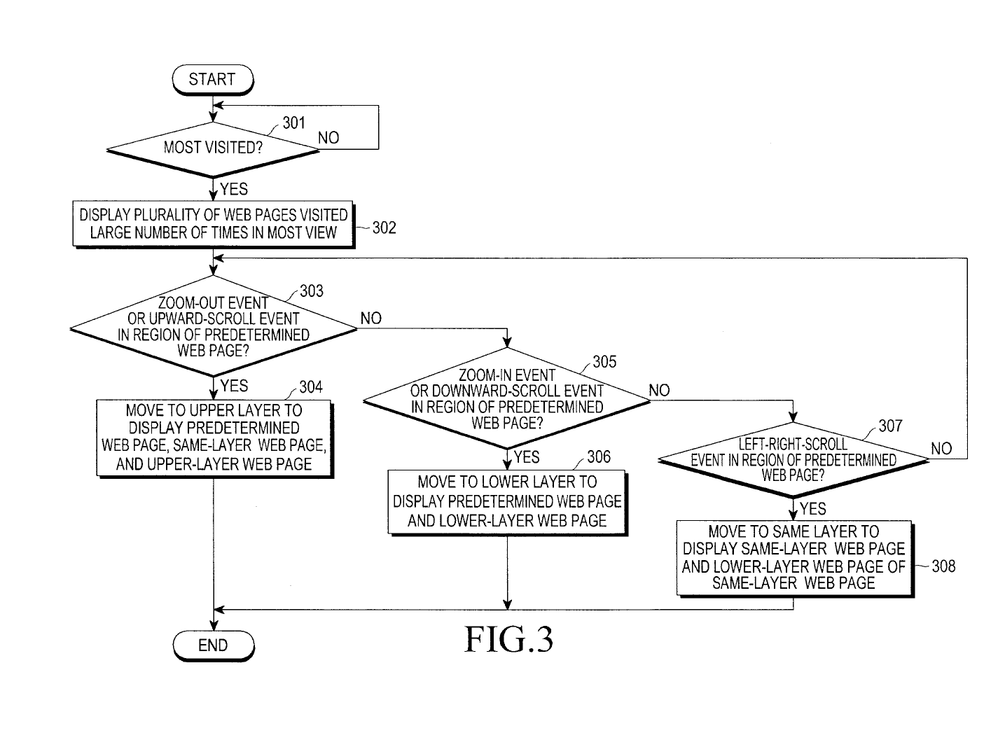

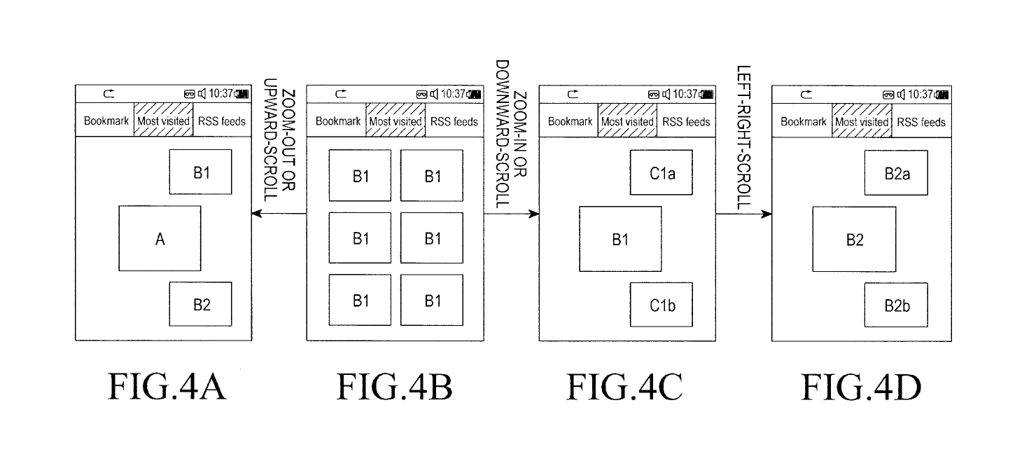

With reference to FIGS. 3 through 4D, a description will be made of a process of moving between web pages displayed in a most view in the foregoing portable terminal.

FIG. 3 is a flowchart illustrating a process of moving between web pages displayed in a most view in the portable terminal according to an embodiment of the present invention, and FIGS. 4A through 4D are diagrams for describing FIG. 3.

Referring to FIGS. 2, 3 and 4, upon selection of “Most visited” in the portable terminal, the controller 110 senses the selection in step 301 and displays a plurality of web pages visited that are mostly visited recently in a window view in step 302 (see FIG. 4b).

Upon occurrence of the zoom-out event or the upward-scroll event in a region of a predetermined web page among the plurality of web pages, the controller 110 senses the occurrence in step 303 and moves to a upper layer of the predetermined web page to display (1) the predetermined web page, (2) a web page in the same layer as the predetermined web page, and (3) a web page in the upper layer of the predetermined web page in step 304(see FIG. 4a)

In step 304, (1) the predetermined web page, (2) the same-layer web page, and (3) the upper-layer web page may be displayed differently by applying different sizes, colors, positions, etc. to those web pages.

Upon occurrence of the zoom-in event or the downward-scroll event in a region of the predetermined web page among the plurality of web pages, the controller 110 senses the occurrence in step 305 and moves to a lower layer of the predetermined web page to display (1) the predetermined web page and (2) a web page in a lower layer of the predetermined page in step 306 (see FIG. 4c).

In step 306, the predetermined web page and the lower-layer web page may be displayed differently by applying different sizes, colors, positions, etc. to those web pages.

Upon occurrence of the left-right-scroll event in a region of the predetermined web page among the plurality of web pages, the controller 110 senses the occurrence in step 307 and moves to the same layer as the predetermined web page to display (1) a web page in the same layer and (2) a web page in a lower layer of the same-layer web page in step 308 (see FIG. 4D).

In step 308, the same-layer web page and the lower-layer web page thereof may be displayed differently by applying different sizes, colors, positions, etc. to those web pages.

Referring to FIG. 4, for example, when a web page A (www.samsung.com) has web pages B1 (www.samsung.com/B1) and B2 (www.samsung.com/B2) in its lower layer, the web page B1 has a web page C1a (www.samsung.com/B1/C1a) and a web page C1b (www.samsung.com/B1/C1b) in its lower layer, the web page B2 has a web page B2a (www.samsung.com/B2/B2a) and a web page B2b (www.samsung.com/B2/B2b) in its lower layer, and these web pages all are visited, among which the web page B1 is most frequently visited, then only the web page B1 is displayed in the most view as shown in FIG. 4B. Then, upon occurrence of the zoom-out event or the upward-scroll event in a region of the web page B1 in FIG. 4B, (1) the web page B1, (2) the web page B2 in the same layer as the web page B1, and (3) the web page A in the upper layer of the web page B1 are displayed as shown in FIG. 4A. Also, upon occurrence of the zoom-in event or the downward-scroll event in a region of the web page B1 in FIG. 4B, the web page B1 and the web pages C1a and C1b in the lower layer of the web page B1 are displayed as shown in FIG. 4C.

As shown in FIGS. 4A through 4D, movement between pages based on a particular event (a zoom-out, zoom-in, or scroll event) occurring in a region of a predetermined web page may be applied to any web page displayed.

It should be noted that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

As can be appreciated from the foregoing description, by providing an apparatus and method for improving a navigation of mostly visited or viewed website pages in upper and lower layers to dynamically enable the movement between related web pages for viewing and selection.

While a detailed embodiment such as a portable terminal has been described in the present invention, various changes may be made without departing from the scope of the present invention. Accordingly, the scope of the present invention should be defined by the claims and equivalents thereof, rather than the described embodiment.

What is claimed is:

1. An apparatus for navigating mostly viewed websites, comprising:
a memory for storing related web pages in a hierarchical manner; and
a controller for, based on a particular event occurring in a viewing window showing a plurality of web pages, displaying a predetermined web page and other web pages from a plurality of layers according to a predefined criteria.

2. The apparatus of claim 1, wherein the controller stores web pages mostly visited relating to the predetermined web page in the memory in a hierarchical manner.

3. The apparatus of claim 1, wherein upon occurrence of a zoom-out event or an upward-scroll event in the viewing window, the controller moves to an upper layer of the predetermined web page to display (1) the predetermined web page, (2) at least one web page in the same layer as the predetermined web page, and (3) at least one web page in the upper layer of the predetermined web page.

4. The apparatus of claim 3, wherein the controller differently displays the predetermined web page and the other web pages in different layer for distinction.

5. The apparatus of claim 1, wherein upon occurrence of a zoom-in event or a downward-scroll event in the viewing window, the controller moves to a lower layer of the predetermined web page to display (1) the predetermined web page and (2) at least one web page in a lower layer of the predetermined page.

6. The apparatus of claim 5, wherein the controller differently displays the predetermined web page along with its lower layer web pages for distinction.

7. The apparatus of claim 1, wherein upon occurrence of a left-right-scroll event in the viewing window, the controller moves to the same layer as the predetermined web page to display (1) a web page in the same layer and (1) at least one web page in a lower layer of the same layer.

8. The apparatus of claim 7, wherein the controller differently displays the web page in the same layer along with its lower layer web page for distinction.

9. A method for navigating mostly viewed websites, the method comprising:
displaying a plurality of web pages mostly viewed; and
based on a particular event occurring on a predetermined web page among a plurality of web pages displayed, displaying a predetermined web page and other web pages from a plurality of layers according to a predefined criteria.

10. The method of claim 9, further comprising storing web pages related to the predetermined web page in the memory in a hierarchical manner.

11. The method of claim 9, wherein the displaying of the predetermined web page comprises:
upon occurrence of a zoom-out event or an upward-scroll event, moving to an upper layer of the predetermined web page; and
displaying (1) the predetermined web page, (2) at least one web page in the same layer as the predetermined web page, and (3) at least one web page in the upper layer of the predetermined web page.

12. The method of claim 11, wherein the predetermined web page, the web page in the same layer as the predetermined web page, and the web page in the upper layer of the predetermined web page are displayed in different sizes for distinction.

13. The method of claim 9, wherein the displaying of the web page comprises:
upon occurrence of a zoom-in event or a downward-scroll event, moving to a lower layer of the predetermined web page; and
displaying (1) the predetermined web page and (2) at least one web page in a lower layer of the predetermined page.

14. The method of claim 13, wherein the predetermined web page and the web page in the lower layer of the predetermined page are displayed in different sizes for distinction.

15. The method of claim 9, wherein the displaying of the web page comprises:
upon occurrence of a left-right-scroll event, moving to the same layer as the predetermined web page; and
displaying (1) a web page in the same layer and (2) at least one web page in a lower layer of the same layer.

16. The method of claim 15, wherein the web page in the same layer and the web page in the lower layer of the same layer are displayed in different sizes for distinction.
